(19) United States
(12) Patent Application Publication
(10) Pub. No.: US 2025/0348213 A1
(43) Pub. Date: Nov. 13, 2025

(54) MANAGEMENT DEVICE, MANAGEMENT METHOD, AND MANAGEMENT PROGRAM

(71) Applicant: Hitachi Vantara, Ltd., Yokohama-shi (JP)

(72) Inventors: Tomoya OOTA, Tokyo (JP); Jun NAKAJIMA, Tokyo (JP)

(73) Assignee: Hitachi Vantara, Ltd., Yokohama-shi (JP)

(21) Appl. No.: 18/817,342

(22) Filed: Aug. 28, 2024

(30) Foreign Application Priority Data
May 13, 2024 (JP) 2024-077828

(51) Int. Cl. G06F 3/06

(52) U.S. Cl. CPC G06F 3/0604; G06F 3/065; G06F 3/0673

(57) ABSTRACT

A management device manages one or more platforms, each having a storage device including one or more volumes, and stores: a policy table defining a policy concerning a volume as a resource and a copy policy concerning copy to define an operation of copying data to the resource; an operation origin table defining an operation origin in the platform where the operation is performed; and a state table for maintaining states of the operation origin. The processor extracts a combination of the resource and the operation from a combination of the policy concerning the volume and the policy concerning the copy. The processor identifies the operation origin from the combination of the resource and operation and determines whether the operation origin is normal, and determines whether the combination of the policies concerning the volume and the copy causes a failure on the operation origin determined to be abnormal.

### CLAIM OF PRIORITY

The present application claims priority from Japanese patent application No. 2024-77828 filed on May 13, 2024, the content of which is hereby incorporated by reference into this application.

### BACKGROUND OF THE INVENTION

The present invention relates to a management device, a management method, and a management program to manage management targets.

Operation management is achieved by combining many management tools in a hybrid cloud storage environment that is composed of various storage devices operating in customer data centers and public clouds. Commands as a plurality of management tools implement a given operation on storage. If a required management tool or storage function fails, the user may be notified of the failure a long time after performing the operation. In such a case, the administrator may need to take measures to restore the intermediate state of the failure.

The following Japanese Unexamined Patent Application Publication No. 2015-170344 discloses a stack management device that performs stack management of a virtual resource group. Suppose a stack generation, modification, or deletion fails on any virtual resource targeted for the stack. Then, the stack management device deletes or retries the entire stack or the unsuccessfully processed virtual resource and rolls back or forward. Suppose not only a stack operation portion but also operations other than the stack operation portion update or delete virtual resources used for a stack. Then, the stack management device reflects a state change in the virtual resource on the stack information DB that indicates the states of the virtual resources used for the stack.

### SUMMARY OF THE INVENTION

The conventional technology extends the time for the user to receive a notification of the unsuccessful operation even if automatic rollback is successful. Rollback is not always successful. It is necessary to know in advance that an operation may fail due to a failure. When a failure is notified to the user, the user views the notification and determines available functions. However, when operation management is abstracted, such as policy-based, it is impossible to determine available abstract operations from the contents of the failure notification.

The present invention aims to inhibit selections that may lead to future problems.

A management device according to a first aspect of the invention disclosed in the present application manages one or more platforms, each having a storage device including one or more volumes. The management device includes a processor to execute a program and a memory device to store the program. The memory device stores a policy table, an operation origin table, and a state table. The policy table defines a policy concerning a volume as a resource and a policy concerning copy to define an operation to copy data to the resource. The operation origin table defines an operation origin in the platform to perform the operation. The state table maintains states of the operation origin. The processor executes an extraction process to extract a combination of the resource and the operation from a combination of the policy concerning the volume and the policy concerning the copy. The processor executes an identification process to identify the operation origin from a combination of the resource and the operation extracted by the extraction process. The processor executes a first determination process to reference the state table and determine whether an operation origin identified by the identification process is normal. The processor executes a second determination process to determine whether a combination of the policy concerning the volume and the policy concerning the copy causes a failure on an operation origin determined to be abnormal by the first determination process. The processor executes an output process to output a determination result from the second determination process.

A management device according to a second aspect of the invention disclosed in the present application manages one or more platforms, each having a storage device including one or more volumes. The management device includes a processor to execute a program and a memory device to store the program. The policy table defines a policy concerning a volume as a resource and a policy concerning copy to define an operation to copy data to the resource. The operation destination table defines an operation destination in the platform to perform the operation. The state table maintains the states of the operation destination. The processor executes an extraction process to extract a combination of the resource and the operation from a combination of the policy concerning the volume and the policy concerning the copy. The processor executes an identification process to identify the operation destination from a combination of the resource and the operation extracted by the extraction process. The processor executes a first determination process to reference the state table and determine whether an operation destination identified by the identification process is normal. The processor executes a second determination process to determine whether a combination of the policy concerning the volume and the policy concerning the copy causes a failure on an operation destination determined to be abnormal by the first determination process. The processor executes an output process to output a determination result from the second determination process.

A representative embodiment of the present invention can inhibit selections that may cause problems in the future. Problems, configurations, and effects other than those described above will become apparent from the description of the following embodiments.

### BRIEF DESCRIPTION OF THE DRAWINGS

FIG. 1 is an explanatory diagram illustrating the configuration of the management system;

FIG. 2 is a block diagram illustrating the hardware configuration of a computer;

FIG. 3 is a block diagram illustrating the configuration of a platform;

FIG. 4 is an explanatory diagram illustrating an example of a copy policy table;

FIG. 5 is an explanatory diagram illustrating an example of a volume policy table;

FIG. 6 is an explanatory diagram illustrating an example of a RTO policy table;

FIG. 7 is an explanatory diagram illustrating an example of an operation origin table;

FIG. 8 is an explanatory diagram illustrating an example of an operation destination table;

FIG. 9 is an explanatory diagram illustrating an example of a state table;

FIG. 10 is a flowchart illustrating a state update process performed by the management device;

FIG. 11 is an explanatory diagram illustrating an example of a determination table;

FIG. 12 is a flowchart illustrating a failure occurrence policy identification process performed by the management device;

FIG. 13 is an explanatory diagram illustrating display screen example 1;

FIG. 14 is an explanatory diagram illustrating display screen example 2;

FIG. 15 is an explanatory diagram illustrating another example of the operation origin table; and

FIG. 16 is an explanatory diagram illustrating another example of the state table.

### DETAILED DESCRIPTION

### First Embodiment

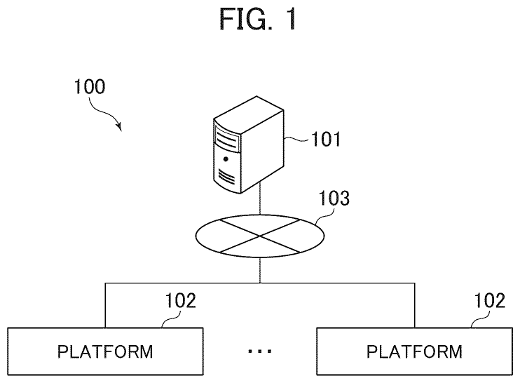

### <FIG. 1 Management System>

FIG. 1 is an explanatory diagram illustrating the configuration of the management system. A management system 100 includes a management device 101 and a platform 102. A network such as the Internet, LAN (Local Area Network), or WAN (Wide Area Network) provides a connection between the management device 101 and the platform 102 and between the platforms 102 to be capable of communication. The management device 101 is a computer that manages the platform 102. The platform 102 is a computer that includes a storage device.

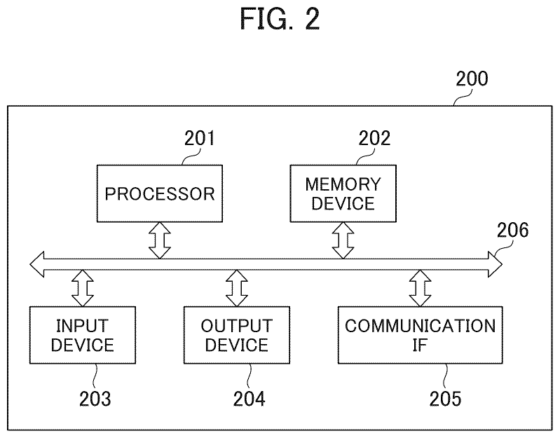

### <FIG. 2 Hardware Configuration of Computer (Management Device 101)>

FIG. 2 is a block diagram illustrating the hardware configuration of a computer. The computer 200 includes a processor 201, a memory device 202, an input device 203, an output device 204, and a communication interface (communication IF) 205. The processor 201, the memory device 202, the input device 203, the output device 204, and the communication IF 205 are connected through a bus 206. The processor 201 controls the computer 200. The memory device 202 provides a working area for the processor 201. The memory device 202 provides a non-temporary or temporary recording medium that stores programs and data. Examples of the memory device 202 include ROM (Read Only Memory), RAM (Random Access Memory), HDD (Hard Disk Drive), and flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 connects to the network 103 and transmits and receives data.

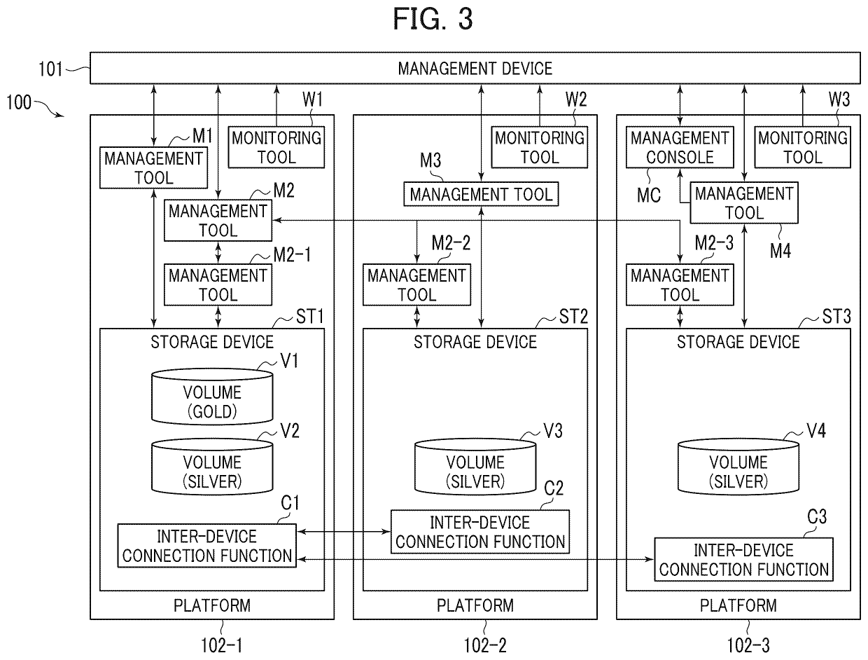

### <FIG. 3 Configuration of Platform 102)

FIG. 3 is a block diagram illustrating the configuration of a platform. FIG. 3 illustrates three platforms 102. However, it may be favorable to use two platforms 102 or four or more platforms 102. Sub-numbers 102-1 through 102-3 distinguish between the three platforms 102.

The platforms 102-1 through 102-3 include monitoring tools W1 through W3, respectively. The notation of monitoring tool W is used when the monitoring tools W1 through W3 are not distinguished. The platform 102-1 includes management tools M1, M2, and M2-1. The platform 102-2 includes management tools M3 and M2-2. The platform 102-3 includes management tools M4 and M2-3. The notation of management tool M is used when management tools M1, M2, M2-1 through M2-3, M3, and M4 are not distinguished. The notation of management tool M2 is used when management tools M2-1 through M2-3 are not distinguished. Monitoring tool W and management tool M may run on a single computer or separate computers.

The platform 102-3 includes a management console MC. The management console MC is a tool that is provided by the cloud vendor and manages the cloud.

The platforms 102-1 through 102-3 include storage devices ST1 through ST3, respectively. The notation of storage devices ST is used when the storage devices ST1 through ST3 are not distinguished. The storage device ST1 includes volumes V1 and V2, and an inter-device connection function C1. The storage device ST2 includes a volume V3 and an inter-device connection function C2. The storage device ST3 includes a volume V4 and an inter-device connection function C3. The notation of volume V is used when volumes V1 through V4 are not distinguished. The notation of inter-device connection function C is used when inter-device connection functions C1 through C3 are not distinguished.

The monitoring tool W is a program that monitors the states of components in the platform 102 including the monitoring tool W. A component is a constituent element in the storage device ST and corresponds to volume V or inter-device connection function C, for example.

The management tool M is a program that is used alone or in combination with other management tools M to execute operations on the storage device ST. Operations on the storage device ST include provisioning, copy origin pairing operation, copy destination pairing operation, and snapshot, for example.

The provisioning generates a specified capacity of storage area from volume V. The copy origin pairing operation designates a specified volume as the copy origin of a copy operation. The copy destination pairing operation designates a volume as the copy destination of a copy operation. The snapshot generates a copy of a provisioned storage area in the storage device ST.

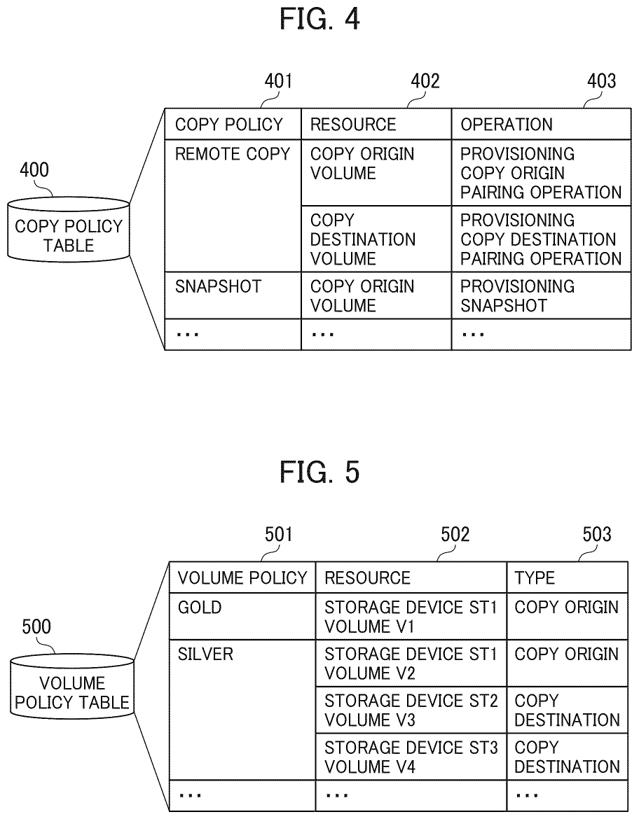

### <FIG. 4 Copy Policy Table>

FIG. 4 is an explanatory diagram illustrating an example of a copy policy table. A copy policy table 400 manages the data copying policy and is stored in the management device 101.

The copy policy table 400 includes fields such as copy policy 401, resource 402, and operation 403. The copy policy 401 indicates the type of copy policy. The copy policy 401 is related to data copying and includes remote copy and snapshot, for example. The remote copy replicates data in the storage device ST to another storage device ST. The resource 402 indicates the type of resource used for the copy policy 401. The operation 403 is a process applied by the copy policy 401 through the use of the resource of the resource 402.

### <FIG. 5 Volume Policy Table>

FIG. 5 is an explanatory diagram illustrating an example of a volume policy table. The volume policy table 500 manages policies related to the volume V and is stored in the management device 101.

The volume policy table 500 includes fields such as volume policy 501, resource 502, and type 503. The volume policy 501 is related to the volume V and is classified into gold, silver, and bronze, for example. High-performance memory devices are assigned to gold, silver, and bronze in this order.

The resource 502 is used by the volume policy 501. The type 503 indicates to which resource 402, copy origin or copy destination, the resource 502 corresponds. The volume policy 501 is not limited to the three types of gold, silver, and bronze.

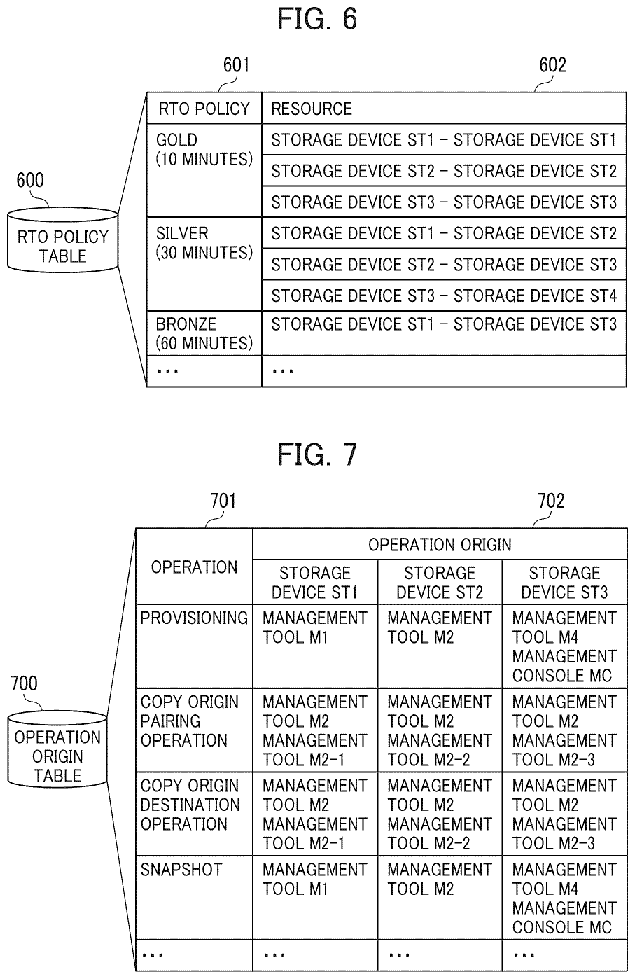

### <FIG. 6 RTO Policy Table>

FIG. 6 is an explanatory diagram illustrating an example of a RTO policy table. The RTO policy table 600 manages policies related to RTO (Recovery Time Objective) and is stored in the management device 101. The RTO policy table 600 includes fields such as RTO policy 601 and resource 602.

Like the volume policy 501, the RTO policy 601 is classified into gold, silver, and bronze, for example. For example, RTO of 10 minutes, 30 minutes, and 60 minutes correspond to the RTO policy 601 of gold, silver, and bronze, respectively. The resource 602 is used for the RTO policy 601. Concretely, for example, the resource 602 is configured in a combination of the storage device ST as a copy origin and the storage device ST as a copy destination.

### <FIG. 7 Operation Origin Table>

FIG. 7 is an explanatory diagram illustrating an example of an operation origin table. The operation origin table 700 defines the correspondence between an operation 701 and an operation origin 702 and is stored in the management device 101.

The operation origin table 700 includes fields such as the operation 701 and operation 702. The operation 701 includes provisioning, copy origin pairing operation, copy destination pairing operation, and snapshot, for example. The operation origin 702 is a subject to execute the operation 701 and is defined for each storage device ST. For example, the management tool M1 is the operation origin 702 when the provisioning operation 701 is performed on the storage device ST1.

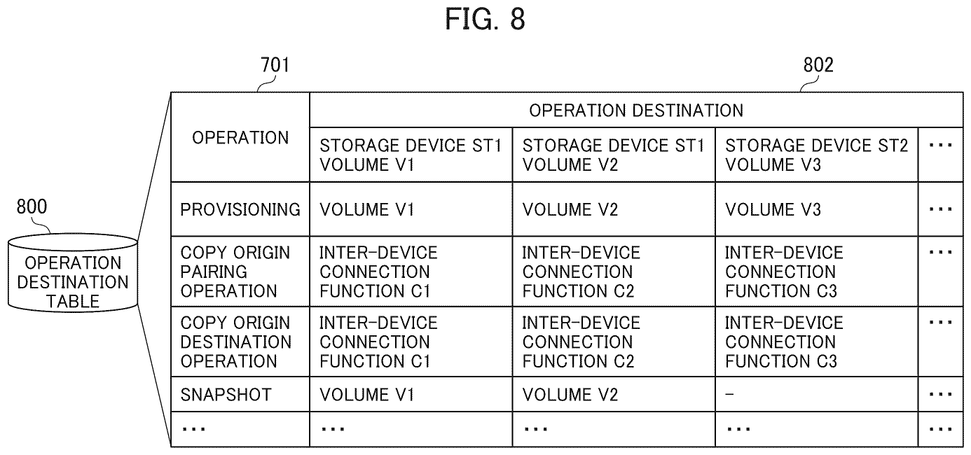

### <FIG. 8 Operation Destination Table>

FIG. 8 is an explanatory diagram illustrating an example of an operation destination table. An operation destination table 800 defines the correspondence between the operation 701 and an operation destination 802 and is stored in the management device 101.

The operation destination table 800 includes fields such as the operation 701 and operation destination 802. The operation destination 802 is an object executed by the operation 701 and is defined for each combination of storage device ST and volume N. For example, suppose the provisioning operation 701 is performed on volume V1 of storage device ST1. Then, volume V1 is the operation destination 802. Suppose the copy origin pairing operation 701 is performed on volume V1 of storage device ST1. Then, the inter-device connection function C1 is an operation object.

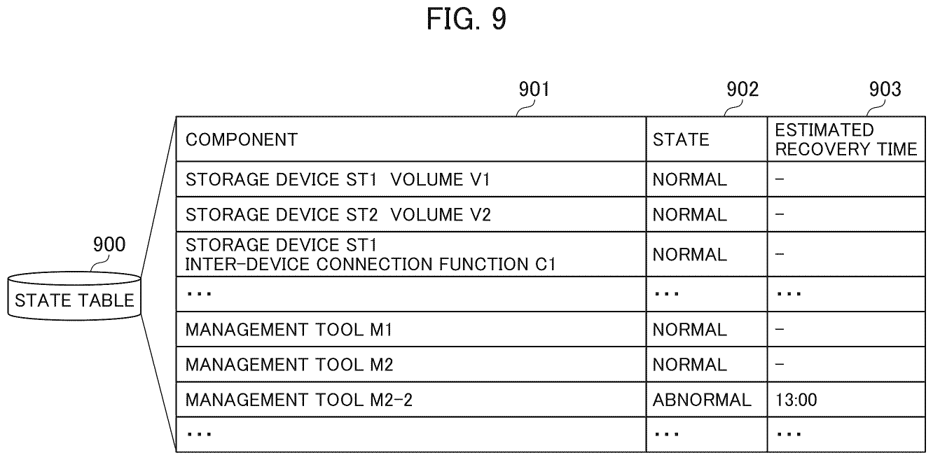

### <FIG. 9 State Table>

FIG. 9 is an explanatory diagram illustrating an example of a state table. The state table 900 maintains the states of components and is stored in the management device 101. The state table 900 includes fields such as component 901, state 902, and estimated recovery time 903.

The component 901 is comparable to a constituent element, the management tool M, or the management console MC in the storage device ST. The constituent element in the storage device ST is comparable to volume V or inter-device connection function C, for example. The state 902 indicates modes of the component 901 that varies over time. The state 902 is updated by the monitoring tool W. The estimated recovery time 903 denotes when the “abnormal” state 902 is estimated to return to “normal.” The estimated recovery time 903 is designated by input from the management device 101.

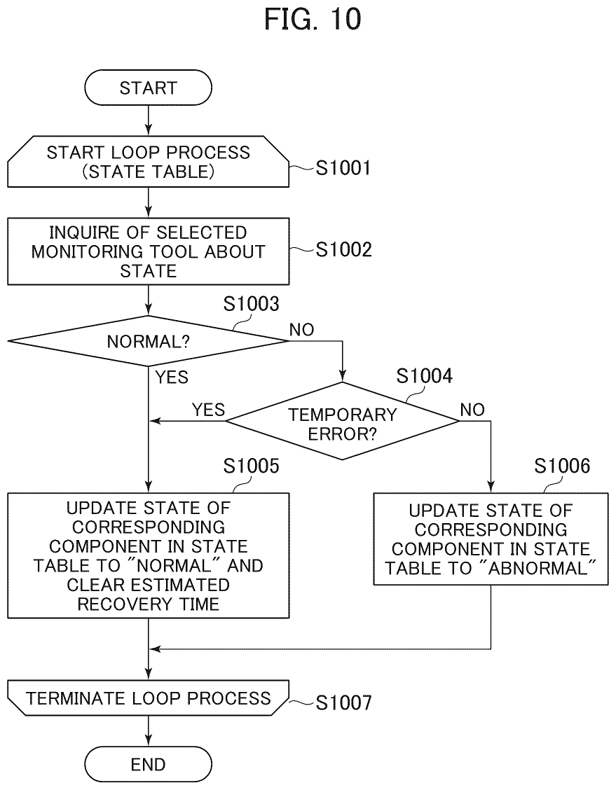

### <FIG. 10 State Update Process>

FIG. 10 is a flowchart illustrating a state update process performed by the management device 101.

### (Step S1001)

The management device 101 selects an unselected monitoring tool W periodically or when an update operation input is accepted. Then, the process proceeds to step S1002.

### (Step S1002)

The management device 101 inquires of the selected monitoring tool W about the state 902 of the component 901. The selected monitoring tool W checks the state 902 of the component 901 in the storage device ST and returns the check result to the management device 101.

### (Step S1003)

The management device 101 determines whether the check result of each component 901 is “normal” or “abnormal.” If the components 901 is determined to be “normal” (step S1003: Yes), the process proceeds to step S1005. If the components 901 is determined to be “abnormal” (step S1003: No), the process proceeds to step S1004.

### (Step S1004)

The management device 101 determines whether the state determined to be “abnormal” is temporary or not. For example, the selected monitoring tool W is commanded to recheck. If the component 901 returns to “normal” after recheck (step S1004: Yes), the process proceeds to step S1005. If the component 901 remains “abnormal” (step S1003: No), the process proceeds to step S1006.

### (Step S1005)

The management device 101 updates the state 902 of the component 901 determined to be “normal” to “normal” and clears the estimated recovery time 903. Then, the process proceeds to step S1007.

### (Step S1006)

The management device 101 updates the state 902 of the component 901 determined to be “abnormal” to “abnormal” and clears the estimated recovery time 903. Then, the process proceeds to step S1007.

### (Step S1007)

The management device 101 terminates the selected monitoring tool W. The process returns to step S1001 if there is an unselected monitoring tool W. The management device 101 terminates the state update process if no unselected monitoring tool W remains.

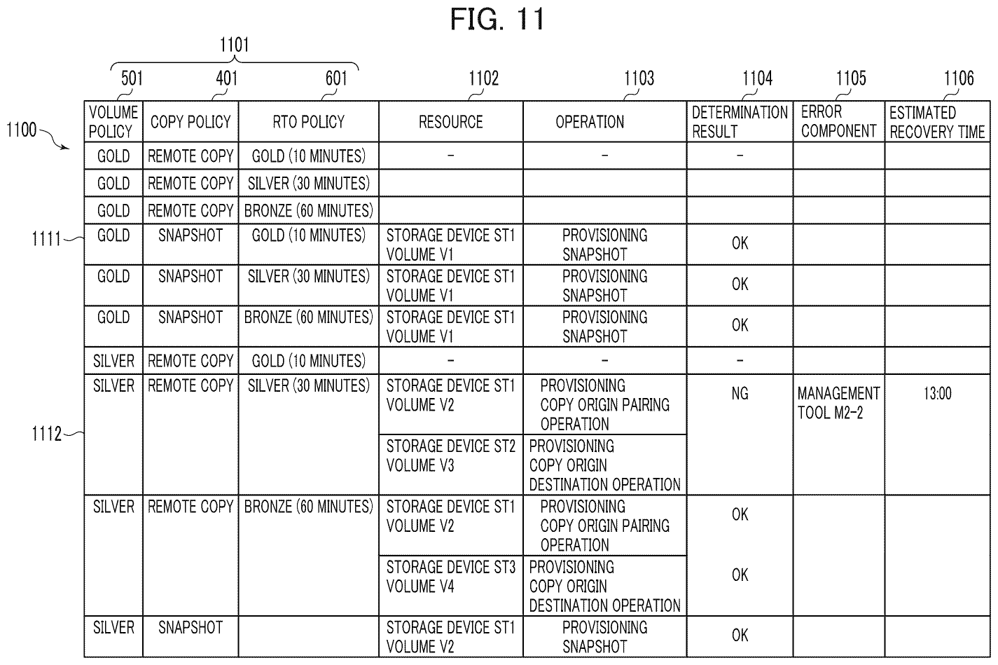

### <FIG. 11 Determination Table>

FIG. 11 is an explanatory diagram illustrating an example of a determination table. The determination table 1100 is generated when a failure occurrence policy identification process described below is performed.

The determination table 1100 includes fields such as policy combination 1101, resource 1102, operation 1103, determination result 1104, error component 1105, and estimated recovery time 1106.

The policy combination 1101 is composed of the volume policy 501, the copy policy 401, and the RTO policy 601. The resource 1102 is comparable to the resource 502 for the volume policy 501 in the policy combination 1101. However, nothing is assigned to an entry devoid of the policy combination 1101.

The operation n 1103 is comparable to the operation 403 corresponding to the copy policy 401. However, nothing is assigned to an entry devoid of the policy combination 1101.

The determination result 1104 indicates whether an error occurs when the operation 1103 is performed based on the policy combination 1101 in the failure occurrence policy identification process described later. If an error occurs, NG is recorded. If no error occurs, OK is recorded.

The error component 1105 corresponds to the component 901 that is determined as NG in the determination result 1104. The estimated recovery time 1106 corresponds to the estimated recovery time 903 in the error component 1105.

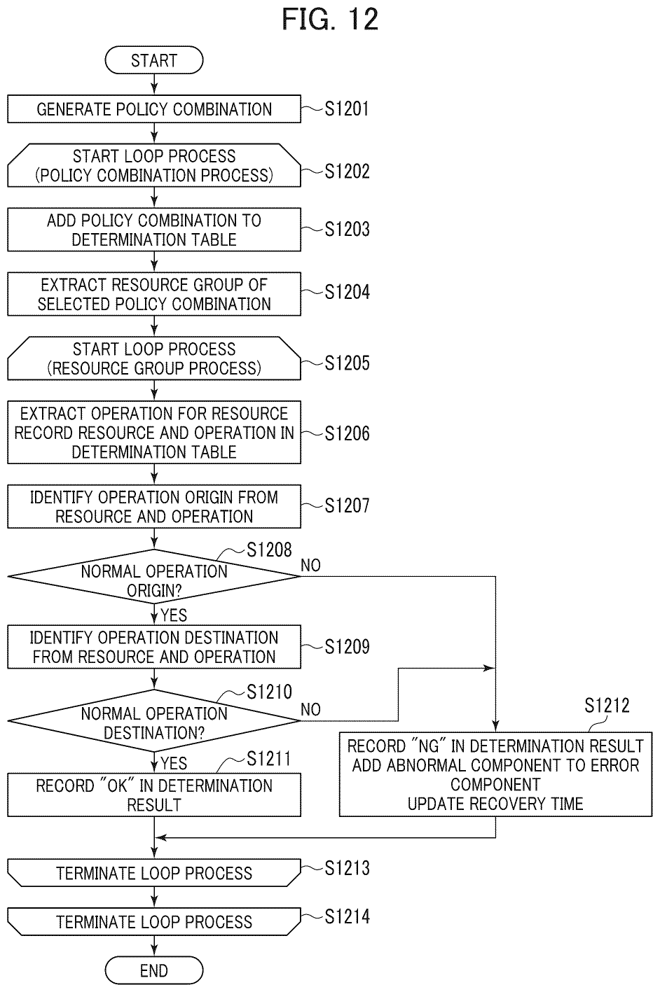

### <FIG. 12 Failure Occurrence Policy Identification Process>

FIG. 12 is a flowchart illustrating the failure occurrence policy identification process performed by the management device 101. In FIG. 12, for example, the management device 101 identifies the policy combination 1101 that causes a failure on the storage device ST or the management tool M even if the operation 403 is performed concretely.

### (Step S1201)

The management device 101 generates the policy combination 1101. Concretely, for example, the management device 101 generates the policy combination 1101 to cover all combinations of the volume policy 501, the copy policy 401, and the RTO policy 601.

### (Step S1202)

The management device 101 selects one unselected policy combinations 1101 and the process proceeds to step S1203. At step S1214, it is determined whether there is an unselected policy combination 1101. If there is the unselected policy combination 1101, the process returns to step S1202 from step S1214. This loop is repeated until no unselected combinations 1101 are left.

### (Step S1203)

The management device 101 adds the selected policy combination 1101 at step S1202 to a new entry in the determination table 1100 and the process proceeds to step S1204.

### (Step S1204)

The management device 101 extracts a resource group of the selected policy combination 1101 and the process proceeds to step S1205. Concretely, for example, the management device 101 extracts, as a resource group, the resource 502 of the volume policy 501 in the selected policy combination 1101.

### Resource Group Extraction Example 1

For example, suppose that the selected policy combination 1101 is composed of the volume policy 501 “gold,” the copy policy 401 “snapshot,” and the RTO policy 601 “gold (10 minutes).” When the volume policy 501 is “gold,” the resource 502 corresponds to “storage device ST1 volume V1.” The resource 402 of the copy policy 401 “snapshot” is only “copy origin volume.” Therefore, the resource 502: “storage device ST1 volume V1” is extracted (see entry 1111).

### Resource Group Extraction Example 2

Suppose the selected policy combination 1101 is composed of the volume policy 501 “silver,” the copy policy 401 “remote copy,” and the RTO policy 601 “silver (30 minutes).” When the volume policy 501 is “silver,” the resources 502 correspond to “storage device ST1 volume V2,” “storage device ST2 volume V3,” and “storage device ST3 volume V4.”

Referring to the resource 502, the “storage device ST1 volume V2” is assigned the type 503 “copy origin.” The “storage device ST2 volume V3” and “storage device ST3 volume V4” are assigned the type 503 “copy destination.”

“Remote copy” as the copy policy 401 corresponds to “copy origin volume” and “copy destination volume” as the resource 402. In entry 1112, the resource 502: “storage device ST1 volume V1” is extracted as the resource 402 “copy origin volume.” The resource 502: “storage device ST2 volume V3” is extracted as the resource 402 “copy destination volume” (see entry 1112).

The management device 101 also extracts a combination of the resource 502: “storage device ST1 volume V1” with the resource 402 “copy origin volume” and the resource 502: “storage device ST3 volume V4” with the resource 402 “copy destination volume.”

### (Step S1205)

The management device 101 selects one unselected resource 1102 from the resource group for the selected policy combination 1101 extracted at step S1204, and then the process proceeds to step S1206. At step S1213, it is determined whether there is an unselected resource 1102. If there is an unselected resource 1102, the process returns from step S1213 to step S1205. This loop is repeated until no unselected resources 1102 remain in the entries of the selected policy combination 1101.

The above-described resource group extraction example 1 extracts only the resource group “storage device ST1 volume V1” based on the selected policy combination 1101 (volume policy 501 “gold,” the copy policy 401 “snapshot,” and the RTO policy 601 “gold (10 minutes)”). Therefore, the resource 502: “storage device ST1 volume V1” is selected as the resource 1102.

The above-described resource group extraction example 2 extracts the resource groups including the combination of “storage device ST1 volume V1” (copy origin volume) and “storage device ST2 volume V3” (copy destination volume) and the combination of “storage device ST1 volume V1” (copy origin volume) and “storage device ST3 volume V4” (copy destination volume) based on the selected policy combination 1101 (the volume policy 501 “silver,” the copy policy 401 “remote copy,” and the RTO policy 601 “silver (30 minutes)”). Therefore, the two combinations above are selected in order as the resources 1102.

### (Step S1206)

The management device 101 extracts the operation 1103 for the selected resource 1102 at step S1205 from the operation 403 in the copy policy table 400. Concretely, for example, the management device 101 identifies the copy policy 401 of the selected policy combination 1101 corresponding to the selected resource 1102 and extracts the operation 403 corresponding to the identified copy policy 401 from the copy policy table 400. The management device 101 adds the selected resource 1102 and the extracted operation 403 to a new entry and then the process proceeds to step S1207.

For example, suppose the selected resource 1102 is “storage device ST1 volume V1” in resource group extraction example 1. Then, the copy policy 401 of the selected policy combination 1101 is “snapshot.” The management device 101 extracts “provisioning and snapshot,” as the operation 403 corresponding to “snapshot,” from the copy policy table 400 and adds it to entry 1111.

Suppose the selected resource 1102 is a combination of “storage device ST1 volume V1” (copy origin volume) and “storage device ST2 volume V3” (copy destination volume) according to resource group extraction example 2. Then, the copy policy 401 for the selected policy combination 1101 is “remote copy.”

The management device 101 extracts the operations 403 corresponding to “remote copy,” namely, “copy origin pairing operation” as the operation 403 on “storage device ST1 volume V1” (copy origin volume) and “provisioning and copy destination pairing operation” as the operation 403 on “storage device ST2 volume V3” (copy destination volume), and adds the extracted operations to entry 1112.

### (Step S1207)

The management device 101 references the operation origin table 700, identifies the operation origin 702 to operate the selected resource 1102 for the extracted operation 403, and the process proceeds to step S1208. Concretely, for example, the management device 101 identifies the operation 701 corresponding to the extracted operation 403 the operation origin table 700. The management device 101 identifies the operation origin 702 corresponding to the storage device ST column for the selected resource 1102 from the row of the identified operation 701.

For example, suppose the selected resource 1102 is “storage device ST1 volume V1” according to the resource group extraction example 1. Then, the extracted operation 403 is “provisioning and snapshot.” Therefore, “management tool M1” is identified as the operation origin 702.

Suppose the selected resource 1102 is a combination of “storage device ST1 volume V1” (copy origin volume) and “storage device ST2 volume V3” (copy destination volume) according to the resource group extraction example 2. Then, the extracted operation 403 includes “provisioning and copy origin pairing operation” and “provisioning and copy destination pairing operation.”

When the extracted operation 403 is “copy origin pairing operation,” the operation origin 702 to operate “storage device ST1 volume V1” (copy origin volume) corresponds to “management tool M2 and management tool M2-1” identified by the operation 701: “copy origin pairing operation” and the storage device ST1. Similarly, “management tool M2” is identified for “provisioning.” Consequently, these are combined to identify “management tool M2 and management tool M2-1.”

When the extracted operation 403 is “copy destination pairing operation,” the operation origin 702 to operate “storage device ST2 volume V3” (copy destination volume) corresponds to “management tool M2 and management tool M2-2” identified by the operation 701: “copy destination pairing operation” and the storage device ST2. Similarly, “management tool M2” is identified for “provisioning.” Consequently, these are combined to identify “management tool M2 and management tool M2-1.”

### (Step S1208)

The management device 101 references the state table 900 and determines whether the state 902 is “normal” concerning each of the operation origin 702 (management tool M and management console MC) identified at step S1207. If the management tool M and the management console MC indicate the state 902 as being “normal” (step S1208: Yes), the process proceeds to step S1209. If the management tool M and the management console MC indicate the state 902 as being “abnormal” (step S1208: No), the process proceeds to step S1212.

### (Step S1209)

The management device 101 references the operation destination table 800, identifies the operation destination 802 to be operated by the extracted operation 403 for the selected resource 1102, and the process proceeds to step S1210. Concretely, for example, the management device 101 identifies the operation 701 corresponding to the extracted operation 403 from the operation destination table 800. The management device 101 identifies the operation destination 802 corresponding to the column of the selected resource 1102 in the row of the identified operation 701.

For example, suppose the selected resource 1102 is “storage device ST1 volume V1” according to the resource group extraction example 1. Then, the extracted operation 403 is “snapshot.” Therefore, “volume V1” is identified as the operation destination 802.

Suppose the selected resource 1102 is a combination of “storage device ST1 volume V1” (copy origin volume) and “storage device ST2 volume V3” (copy destination volume) according to the resource group extraction example 2. Then, the extracted operation 403 includes “copy origin pairing operation” and “copy destination pairing operation.”

When the extracted operation 403 is a “copy origin pairing operation,” the operation destination 802 operated on the “storage device ST1 volume V1” (copy origin volume) is “inter-device connection function C1” identified by the operation 701: “copy origin pairing operation” and “storage device ST1 volume V1.”

When the extracted operation 403 is a “copy destination pairing operation,” the operation destination 802 operated on the “storage device ST2 volume V3” (copy destination volume) is “inter-device connection function C3” identified by the operation 701: “copy destination pairing operation” and “storage device ST2 volume V3.”

### (Step S1210)

The management device 101 references the state table 900 and determines whether the state 902 is “normal” concerning each of the operation destination 802 identified at step S1209. If the operation destination 802 indicates the state 902 as being “normal,” the process proceeds to step S1211. If the operation destination 802 indicates the state 902 as being “abnormal,” the process proceeds to step S1212.

### (Step S1211)

The management device 101 records “OK” in the determination result 1104 of the new entry and the process proceeds to step S1213.

### (Step S1212)

The management device 101 records “NG” in the determination result 1104 of the new entry and records the component 901 indicating the state 902 “abnormal” as the error component 1105. The component 901 whose state 902 is determined to be “abnormal” at step S1208 is the operation origin 702, namely, management tool M2-2. Therefore, the error component 1105 is identified as management tool M2-2 (see entry 1111).

The component 901 whose state 902 is determined to be “abnormal” at step S1210 is the operation destination 802, namely, volume V or inter-device connection function C of the storage device ST. Therefore, the error component 1105 is identified as volume V or inter-device connection function C of the storage device ST.

As above, the management device 101 determines the policy combination 1101 that causes a failure on the operation origin 702 determined to be abnormal at step S1208. Alternatively, the management device 101 determines the policy combination 1101 that causes a failure on the operation destination 802 determined to be abnormal at step S1210.

### (Step S1213)

The management device 101 determines whether the unselected resource 1102 remains in the resource group extracted at step S1204. If there is the unselected resource 1102, the process returns to step S1205. If no unselected resource 1102 remains, the process proceeds to step S1214.

### (Step S1214)

The management device 101 determines whether there is the unselected policy combination 1101. If there is the unselected policy combination 1101, the process returns to step S1202. If there is no unselected policy combination 1101, the failure occurrence policy identification process terminates.

The management device 101 identifies the policy combination 1101 that causes a failure on the storage device ST or the management tool M even if the operation 403 is performed.

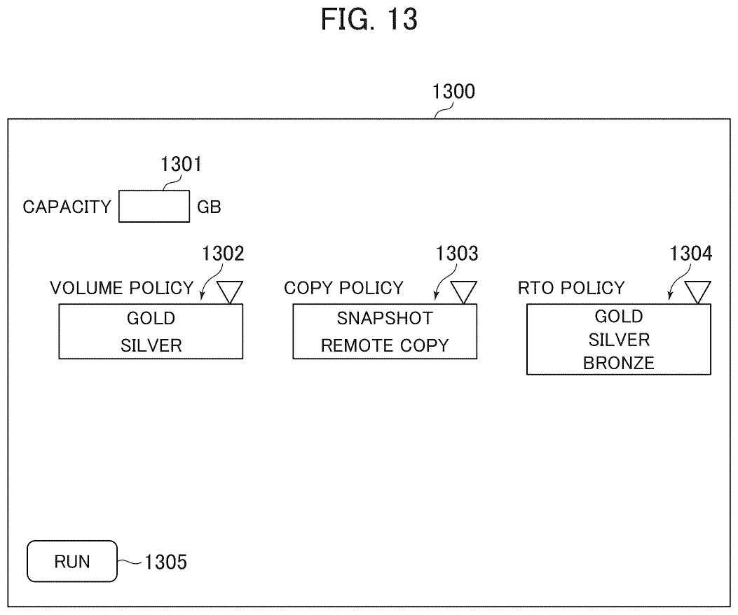

### <FIG. 13 Display Screen 1>

FIG. 13 is an explanatory diagram illustrating display screen example 1. The display screen 1300 illustrated in FIG. 13 is displayed on a display device as an example of the output device 204 of the management device 101, or on a display of another computer that can communicate with the management device 101. An instruction to display the display screen 1300 is accepted by the input device 203 of the management device 101, or by the input device 203 of another computer that can communicate with the management device 101.

When an operation to display the display screen 1300 is performed, the management device 101 performs the failure occurrence policy identification process in FIG. 12 and then displays the display screen 1300. FIG. 13 illustrates a display screen when no failure occurrence policy is identified due to performing the failure occurrence policy identification process in FIG. 12. The failure occurrence policy identification process in FIG. 12 may be performed in advance, periodically, or after the display screen 1300 is displayed.

The display screen 1300 includes a capacity input area 1301, a volume policy selection portion 1302, a copy policy selection portion 1303, an RTO policy selection portion 1304, and a run button 1305.

The capacity input area 1301 accepts input of the capacity of data to be provisioned. The volume policy selection portion 1302 provides a user interface that accepts the selection of the volume policy 501. The copy policy selection portion 1303 provides a user interface that accepts the selection of the copy policy 401. The RTO policy selection portion 1304 provides a user interface that accepts the selection of the RTO policy 601. The run button 1305 provides a user interface that is pressed to accept the provisioning.

When the run button 1305 is pressed, the management device 101 applies the provisioning of the capacity entered in the capacity input area 1301 to the resource 1102 identified by the policy combination 1101 selected through the use of the volume policy selection portion 1302, the copy policy selection portion 1303, and the RTO policy selection portion 1304.

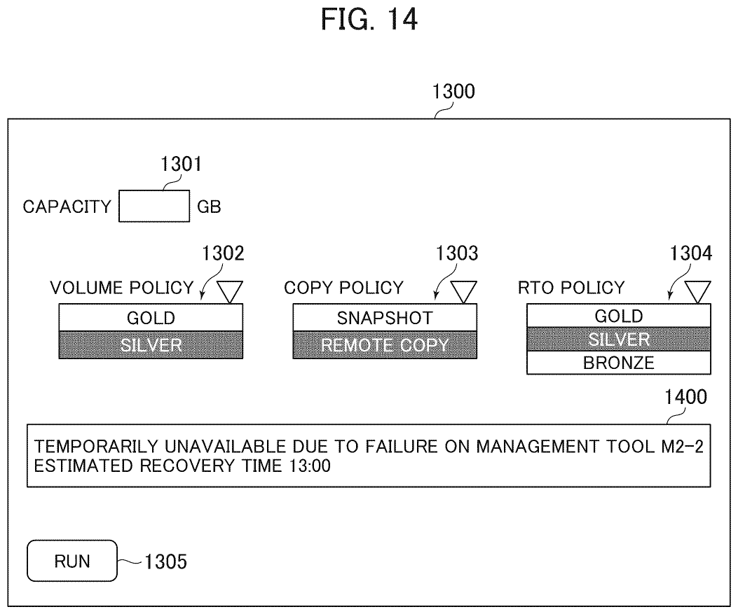

### FIG. 14 Display Screen 2>

FIG. 14 is an explanatory diagram illustrating display screen example 2. FIG. 14 illustrates a display screen when the failure occurrence policy is identified due to executing the failure occurrence policy identification process in FIG. 12. FIG. 14 illustrates a display screen when the policy combination 1101 (entry 1112 recording the error component 1105 in FIG. 11) of the volume policy 501 “silver,” the copy policy 401 “remote copy,” and the RTO policy 601 “silver” is identified as failure occurrence policy.

Concretely, for example, the volume policy selection portion 1302 highlights the volume policy 501 “silver.” The copy policy selection portion 1303 highlights the copy policy 401 “remote copy.” The RTO policy selection portion 1304 highlights the RTO policy 601 “silver.” The run button 1305 cannot be pressed when at least one policy is highlighted. The failure occurrence policy may be hidden in the volume policy selection portion 1302, the copy policy selection portion 1303, and the RTO policy selection portion 1304.

When a combination of failure occurrence policies is selected, the management device 101 displays the failure information 1400 on the display screen 1300. The displayed failure information 1400 includes the error component 1105 and the estimated recovery time 1106.

According to the first embodiment, the management device 101 manages the policy combination 1101, making it possible to identify the operation origin 702 and the operation destination 802. The management device 101 references the state table 900 and thereby identifies and displays the policy combination 1101 (failure policy) that fails if executed.

The user can be inhibited from selecting the policy combination 1101 that is likely to fail. The policy combination 1101 (failure policy) that will fail if executed is displayed to be inexecutable. It is possible to prevent the operation 701 likely to fail from occurring. By referencing the failure information 1400, the user can determine which the component 901 fails.

### Second Embodiment

The description below explains the second embodiment. According to the first embodiment, the management device 101 identifies the management tool M as the operation origin 702 in the operation origin table 700. The second embodiment finely defines the granularity of the operation origin 702. The API (Application Programming Interface) used by the management tool M to execute the operation 701 is identified as the operation origin. The second embodiment mainly describes differences from the first embodiment and omits the parts common to the first embodiment.

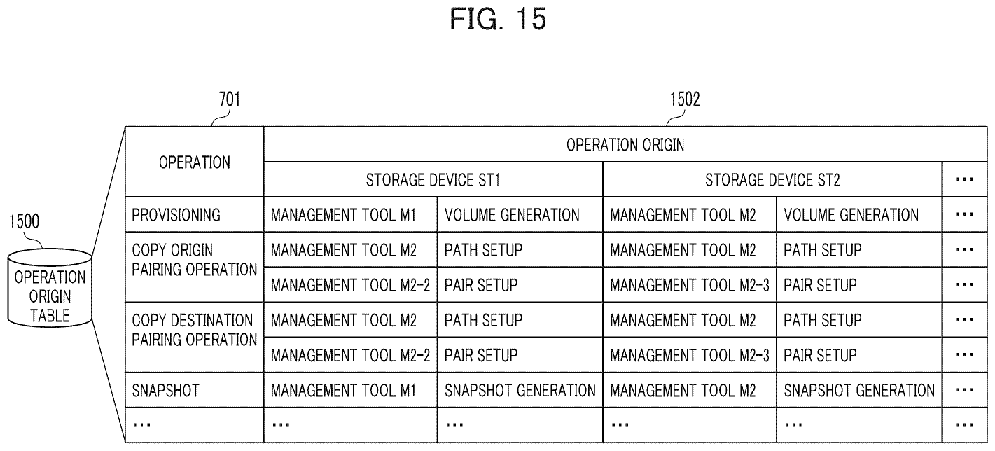

### <FIG. 15 Operation Origin Table>

FIG. 15 is an explanatory diagram illustrating another example of the operation origin table. An operation origin table 1500 is maintained in the management device 101 and specifies the correspondence between the operation 701 and an operation origin 1502. The operation origin 1502 differs from the operation origin table 700 in FIG. 7.

The operation origin 702 specifies the management tool M as an operation origin for each storage device ST. Meanwhile, the operation origin 1502 specifies the API, as an operation origin, used for the management tool M to perform the operation 701. The API includes functions and commands required to execute the operation 701. When the operation 701 is a copy origin pairing operation, for example, the storage device ST1 executes an API using the management tool M2 assigned with path setup and executes an API using the management tool M2-2 assigned with pair setup.

When the operation 701 is provisioning, the storage device ST1 executes an API using the management tool M1 assigned with volume generation. When the operation 701 is snapshot, the storage device ST1 executes another API using the management tool M1 assigned with snapshot generation different from volume generation.

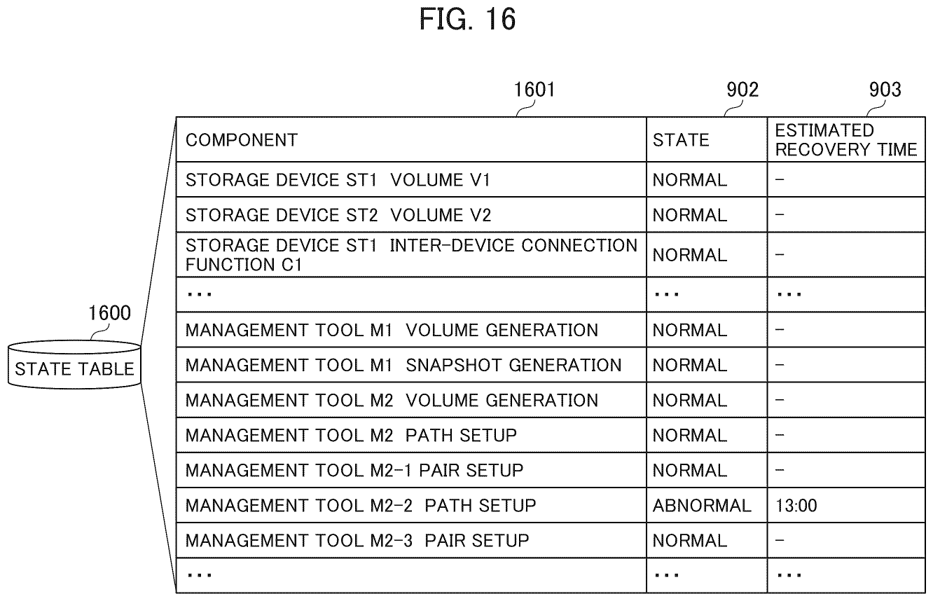

### <FIG. 16 State Table>

FIG. 16 is an explanatory diagram illustrating another example of the state table. A state table 1600 is stored in the management device 101 and maintains component states. The state table 1600 differs from the state table 900 in FIG. 9 in that the component 1601 specifies the management tool M and the API used to execute the associated operation 701 corresponding to FIG. 15.

At step S1207 of the failure occurrence policy identification process in FIG. 12, the management device 101 references the operation origin table 1500 and identifies the operation origin 1502 for the extracted operation 403 to operate the selected resource 1102. Then, the process proceeds to step S1208.

At step S1208, the management device 101 references the state table 1600 and determines whether the state 902 is “normal” concerning each of the operation origin 1502 identified at step S1207. Suppose the state 902 of the management tool M is determined to be “abnormal” (step S1208: No). At step S1212, the management device 101 records “NG” in the determination result 1104 of the new entry. The component 901 (management tool M and the API used to execute its operation 701) whose state 902 is determined to be “abnormal” is recorded as the error component 1105.

The second embodiment can identify the error component 1105 whose granularity is finer than the first embodiment. Therefore, the failure information 1400 on the display screen 1300 in FIG. 14 indicates “temporarily unavailable due to API pair setup failure on management tool M2-2.” By referencing the failure information 1400, the user can determine which API of which management tool M fails.

### <Modification 1>

The above-described first and second embodiments use the policy combination 1101 of the copy policy 401, the volume policy 501, and the RTO policy 601. Alternatively, the policy combination 1101 may include at least the copy policy 401 and the volume policy.

### <Modification 2>

According to the above-described first and second embodiments, the management device 101 identifies the operation origins 702 and 1502 (step S1207), checks for the normality (step S1208), identifies the operation destination 802 (step S1209), and checks for the normality (step S1210). Alternatively, the management device 101 may identify the operation origins 702 and 1502 (step S1207), check for the normality (step S1208), and omit steps S1209 and S1210. Alternatively, the management device 101 may identify the operation destination 802 (step S1209) and check for the normality (step p S1210) without performing steps S1207 and S1208.

The present invention is not limited to the above-described embodiments and includes various modifications and comparable configurations within the spirit of the appended claims. For example, the embodiments are described in detail to explain the present invention comprehensibly. The present invention is not necessarily limited to all the configurations described above. Part of the configuration of one embodiment may be replaced with the configuration of another embodiment. Part of the configuration of one embodiment may be added to the configuration of another embodiment. Part of the configuration of each embodiment may be added, deleted, or replaced with another configuration.

All or part of the above-described configurations, functions, processing portions, and processing means, for example, may be embodied as hardware by designing them as integrated circuits, for example, or may be embodied as software so that a processor can interpret and execute a program to implement each function.

Information such as programs, tables, and files to implement each function can be stored in memory devices such as memory, hard disks, and SSDs (Solid State Drives), or recording media such as IC (Integrated Circuit) cards, SD cards, and DVDs (Digital Versatile Discs).

Control lines and information lines are illustrated as necessary for explanation and do not completely show all control lines and information lines needed for implementation. It may be favorable to consider that almost all configurations are interconnected practically.

1. A management device that manages one or more platforms, each having a storage device including one or more volumes, comprising:
a processor to execute a program, and
a memory device to store the program,
wherein the memory device stores a policy table, an operation origin table, and a state table;
wherein the policy table defines a policy concerning a volume as a resource and a policy concerning copy to define an operation to copy data to the resource;
wherein the operation origin table defines an operation origin in the platform to perform the operation;
wherein the state table maintains states of the operation origin;
wherein the processor executes:
an extraction process to extract a combination of the resource and the operation from a combination of the policy concerning the volume and the policy concerning the copy;
an identification process to identify the operation origin from a combination of the resource and the operation extracted by the extraction process;
a first determination process to reference the state table and determine whether an operation origin identified by the identification process is normal;
a second determination process to determine whether a combination of the policy concerning the volume and the policy concerning the copy causes a failure on an operation origin determined to be abnormal by the first determination process; and
an output process to output a determination result from the second determination process.

2. The management device according to claim 1,
wherein the processor executes an update process that monitors the operation origin and updates the state of the state table; and
wherein, in the first determination process, the processor references the latest state table updated by the update process and determines whether an operation origin identified by the identification process is normal.

3. The management device according to claim 1,
wherein the operation origin is a management program that is installed on the platform and manages the platform or another platform.

4. The management device according to claim 1,
wherein the operation origin is a program and an API used to execute the program; and
wherein the program is installed on the platform that manages the platform or other platforms.

5. The management device according to claim 1,
wherein the policy concerning the volume includes the resource and a type to determine whether the resource is a copy origin or destination of data; and
wherein the policy concerning the copy includes a resource and an operation;
wherein the resource specifies whether the resource to be copied is a copy origin or destination, and
wherein the operation performs the copy on a resource of the resource type.

6. The management device according to claim 1,
wherein the policy table defines an RTO policy that defines a storage device to which a policy concerning Recovery Time Objective is applied;
wherein the operation origin table defines the operation origin for each storage device; and
wherein, in the extraction process, the processor extracts a combination of the resource and the operation from a combination of the policy concerning the volume, a policy concerning the copy, and a policy concerning Recovery Time Objective.

7. The management device according to claim 1,
wherein the memory device stores an operation destination table that defines the operation and an operation destination in the storage device where the operation is performed;
wherein the status table maintains states of the operation origin and the operation destination;
wherein the processor executes a second identification process and a second determination process;
wherein the second identification process identifies the operation destination for each combination of the resource and the operation extracted by the extraction process, and
wherein the second determination process references the state table and determines whether the operation destination identified by the second identification process is normal; and
wherein in the second determination process, the processor determines whether a combination of the policy concerning the volume and the policy concerning the copy causes a failure on an operation destination determined to be abnormal by the second determination process.

8. The management device according to claim 1,
wherein, in the output process, the processor displays the combination causing a fault as being unselectable and displays a combination other than the combination causing a fault as being selectable.

9. The management device according to claim 1,
wherein, in the output process, the processor hides the combination causing a fault and displays a combination other than the combination causing a fault as being selectable.

10. A management method executed by a management device that manages one or more platforms each having a storage device including one or more volumes,
wherein the management device includes a processor to execute a program and a memory device to store the program;
wherein the memory device stores a policy table, an operation origin table, and a state table;
wherein the policy table defines a policy concerning a volume as a resource and a policy concerning copy to define an operation to copy data to the resource;
wherein the operation origin table defines an operation origin in the platform to perform the operation;
wherein the state table maintains states of the operation origin;
wherein the processor executes:
an extraction process to extract a combination of the resource and the operation from a combination of the policy concerning the volume and the policy concerning the copy;
an identification process to identify the operation origin from a combination of the resource and the operation extracted by the extraction process;
a first determination process to reference the state table and determine whether an operation origin identified by the identification process is normal;
a second determination process to determine whether a combination of the policy concerning the volume and the policy concerning the copy causes a failure on an operation origin determined to be abnormal by the first determination process; and
an output process to output a determination result from the second determination process.

11. A non-transitory recording medium with instructions stored thereon for causing a processor to execute a process that manages one or more platforms each having a storage device including one or more volumes,
wherein the processor can access a memory device that stores a volume policy table, a copy policy table, an operation origin table, and a state table;
wherein the memory device stores a policy table, an operation origin table, and a state table;
wherein the policy table defines a policy concerning a volume as a resource and a policy concerning copy to define an operation to copy data to the resource;
wherein the operation origin table defines an operation origin in the platform to perform the operation;
wherein the state table maintains states of the operation origin;
wherein the management program allows the processor to execute:
an extraction process to extract a combination of the resource and the operation from a combination of the policy concerning the volume and the policy concerning the copy;
an identification process to identify the operation origin from a combination of the resource and the operation extracted by the extraction process;
a first determination process to reference the state table and determine whether an operation origin identified by the identification process is normal;
a second determination process to determine whether a combination of the policy concerning the volume and the policy concerning the copy causes a failure on an operation origin determined to be abnormal by the first determination process; and
an output process to output a determination result from the second determination process.
